(19) United States
(12) Patent Application Publication
(10) Pub. No.: US 2023/0161785 A1
(43) Pub. Date: May 25, 2023

(54) INTEGRITY IN A DATA WAREHOUSE (DWH) OF AN EVENT DRIVEN DISTRIBUTED SYSTEM

(71) Applicant: VMware, Inc., Palo Alto, CA (US)

(72) Inventors: Igal BAKSHAN, Herzliya (IL); Amnon ALTONY, Herzliya (IL); Tal YEDGAR, Herzliya (IL); Or GABAY, Herzliya (IL); Yaniv AHARONI, Herzliya (IL)

(21) Appl. No.: 17/456,293

(22) Filed: Nov. 23, 2021

(51) Int. Cl. G06F 16/25; G06F 16/21

(52) U.S. Cl. CPC G06F 16/25; G06F 16/217

(57) ABSTRACT

A method for data validation and reconciliation of data stored in a data warehouse (DWH) by multiple microservices in communication with the DWH, is provided. The method generally includes receiving, by each microservice, records of data maintained in the DWH, obtaining, by each microservice, corresponding records of data that correspond to the records of data maintained in the DWH, performing, by each microservice, a validation process to validate the records of data maintained in the DWH by comparing the records of data maintained in the DWH with the corresponding records of data, determining, by one or more microservices of the multiple microservices, the comparison indicates discrepancies exist in the records of data maintained in the DWH, and issuing, by the microservices, one or more reconciliation events to remediate the discrepancies which exist in the records of data maintained in the DWH.

### BACKGROUND

Advances in cloud technology and mobile applications have enabled businesses and information technology (IT) users to interact in entirely new ways. One of the most rapidly growing technologies in this sphere is business intelligence (BI), and associated concepts such as big data and data mining. BI is a set of tools and techniques for the transformation of raw data into meaningful and useful pieces of information for analysis purposes. BI entails the management of large amounts of unstructured data to help in identifying, improving, and possibly defining new strategic opportunities. In particular, BI aims at providing historical, current, and predictive views of an organization's operations.

Unfortunately, apart from being unstructured, data of interest for BI analysis is often stored among multiple distributed data sources, such as application log files and transaction applications. Thus, in many cases, the first step toward use of such data is the creation of a single and unified repository, collecting and organizing all the needed pieces of information, namely, a data warehouse (DWH).

In some cases, a DWH is a core constituent of an organization's Decision Support System (DSS). In particular, a DWH is a system that aggregates data from different sources into a single, central repository. The DWH may structure the data using predefined schemas, such as those designed to support data analysis, data mining, artificial intelligence (AI), machine learning (ML), and/or the like. A DWH system may enable an organization to run powerful analytics on large volumes (e.g., petabytes and petabytes) of historical data in ways that a standard database cannot. In some cases, a DWH is hosted in a cloud and uses the space and compute power allocated by a cloud provider to integrate and store data.

Data warehousing in microservice architecture provides a solution to maintain an accurate, centralized DWH while also allowing all parts of a system to be self-governing. In particular, microservices (or microservices architecture), such as in cloud environment or an on-premises environment, provide an approach in which a single application is composed of many loosely coupled and independently deployable smaller components or processes, which may be referred to as microservices. Microservices work together as a whole to comprise an application, yet each can be independently scaled, continuously improved, and/or quickly iterated through automation and orchestration processes. In some cases, microservices run in containers. Each microservice owns its domain data and logic, and may have its own technology stack, inclusive of a database and data management model. Thus, integrating a DWH with microservices architecture allows for increased modularity and scalability, given microservices have their own infrastructure and database, while also centralizing data from each microservice, such as to facilitate analysis and ad-hoc querying.

In some implementations, such as by leveraging cloud infrastructure, the DWH may use an event-driven approach to simplify the ingestion of data from each microservice. In particular, a DWH uses event sourcing such that ideally all changes to data, specific to each microservice, are captured at the DWH. Event sourcing may attempt to ensure that every change to a state of a microservice is stored in an event, and these events are themselves stored in sequential order. Events may be issued when a specific event happens at a microservice, and such events may include events for creating, updating, and deleting (CUD). As an illustrative example, a microservice dedicated to handle finances of an organization may be configured to manage invoices. Using event sourcing, this type of microservice may capture events, such as invoice creation, paid invoices, updates to invoices, etc., in multiple events, which are published to the DWH. Such events published to the DWH may be used to create, update, and delete data stored in the DWH, and each of these events may be stored in sequential order according to a schema of the DWH.

In some DWHs, events may be stored according to a star schema. A star schema is a database organizational structure optimized for use in a DWH that uses a single fact table to store transactional or measured data, and one or more smaller dimensional tables that store attributes about the data. It is called a star schema because the fact table sits at the center of the logical diagram, and the small dimensional tables branch off to form the points of the star. In event-driven DWH architecture, CUD events may constitute the dimensions tables such that rows are added to the tables each time an event at a microservice occurs, and is published to the DWH.

In some other implementations, the DWH may use mechanisms, such as data scraping, to transfer data from each microservice to the DWH. Data scraping, or data extraction, is an automated process for extracting data from output coming from another source, in this case a microservice. Data scraping often involves ignoring binary data (e.g., images), display formatting, redundant labels, superfluous commentary, and other information which is either irrelevant or hinders automated processing. A set of initialization and scraping scripts (for example, written in Python) may be used to pull the data from each of the different microservices for scraping of the data.

Data integration is an important aspect of a DWH. However, while event-driven and data scraping approaches seek to guarantee that all changes to data (e.g., stored in one or more databases) of each microservice are captured at the DWH, this may not always be the case. In particular, when validating data in a DWH, configured to use either an event-driven approach or a data scraping approach to integrate data from each microservice, against system of records (SORs) (e.g., information storage systems that are the authoritative data source for each given microservice) for each microservice, often inconsistencies, missing records, and/or spare records are encountered. And further, in most cases, such inconsistencies, missing records, and/or spare records are prevalent at the DWH (while data stored at each SOR associated with each microservice tends to be accurate).

Possible inconsistencies and redundancies at DWHs may be attributed to a number of different factors, including bugs (e.g., loss of Unicode values due to a software defect) in the ingestion process, manual manipulation (e.g., modification and deletion) of data stored in each database associated with each microservice, inconsistencies (e.g., due to delays in incorporating events) between SORs and their associated microservice, to name a few. Additionally, where data scraping techniques are used, possible inconsistencies may be attributed to scraping of inaccurate data. For example, where a database value is null it may be translated to some default value, but when scraping the data from the database, the default value may not be known, thus creating inconsistencies between data at the microservice and data at the DWH.

Further, in DWHs which use data scraping techniques, inconsistencies and redundancies encountered at the DWH present additional challenges. For example, to correct such discrepancies in the DWH, data in the DWH must be continuously deleted and scraped. Such a process is tedious and often imposes an additional burden to perpetually implement and update scripts for scraping.

Accordingly, there exists a need for reliable data in DWHs. In particular, when data passes from the microservices of the application-oriented operational environment to the DWH, it is important that inconsistencies and redundancies are resolved so that the DWH may be able to provide an integrated and reconciled view of data of the organization. Accordingly, solutions for maintaining the integrity of data in a DWH are desired.

It should be noted that the information included in the Background section herein is simply meant to provide a reference for the discussion of certain embodiments in the Detailed Description. None of the information included in this Background should be considered as an admission of prior art.

### BRIEF DESCRIPTION OF THE DRAWINGS

FIG. 1 depicts an example schematic architecture for validation and reconciliation of data in a data warehouse (DWH) with which embodiments of the present disclosure may be implemented.

FIG. 2 depicts example virtual components of a computing environment with which embodiments of the present disclosure may be implemented.

FIG. 3A is an example workflow for single record validation and reconciliation, according to an example embodiment of the present application.

FIG. 3B is an example workflow for record count validation and reconciliation, according to an example embodiment of the present application.

FIG. 4 illustrates an example reconciliation event for remediation of a record in a DWH, according to an example embodiment of the present application.

FIG. 5 is a flowchart illustrating a method for data validation and reconciliation of data stored in a DWH by a microservice in communication with the DWH, according to an example embodiment of the present application

### DETAILED DESCRIPTION

Aspects of the present disclosure introduce an approach for data validation and reconciliation, such as to solve conflicts among data stored in different sources. Data validation refers to the process of ensuring the accuracy and/or quality of data, while data reconciliation is a term typically used to describe a verification phase during data integration where target data is compared against original and ongoing transformed source data to ensure that the integration architecture has moved and/or transformed data correctly. For example, data validation and reconciliation in information systems describe actions of comparing source and target data, identifying differences in the source and target data (e.g., no differences are expected), and troubleshooting such differences to maintain data consistency of the system.

Data validation and reconciliation may be aspects of data warehousing. Data warehousing is the process of constructing and using a data warehouse (DWH). A DWH is constructed by integrating data from multiple heterogeneous sources, such as sources that support analytical reporting, structured and/or ad hoc queries, and decision making. In the process of extracting data from one source and then transforming the data and loading it into the DWH, the nature of the data may change, and in some cases, might become lost in transformation. A validation and reconciliation process helps to identify such loss of information, as well as discrepancies among the DWH and its sources during and after integration.

Accordingly, aspects of the present disclosure provide an approach for data validation and reconciliation of data in a microservices architecture involving a DWH. As mentioned previously, integrating a DWH with microservices architecture allows for increased modularity and scalability, given microservices have their own infrastructure and database, while also centralizing data from each microservice to facilitate analysis and ad-hoc querying. The approach for data validation and reconciliation presented herein describes an automated process used to detect discrepancies between data stored in the DWH and data stored in a system of record (SOR) associated with each microservice to remediate such discrepancies when detected. In particular, upon detection of one or more data discrepancies, one or more microservices, e.g., one or more microservices that own/created the data that is inaccurate and/or missing in the DWH, may issue a reconciliation event to remedy any data discrepancies in the DWH, to in turn, maintain data integrity of the system. While the data validation and reconciliation process described herein may be described with respect to cloud computing architecture, any suitable architecture may be considered, including on-premises architectures and hybrid architectures including on-premises and cloud devices.

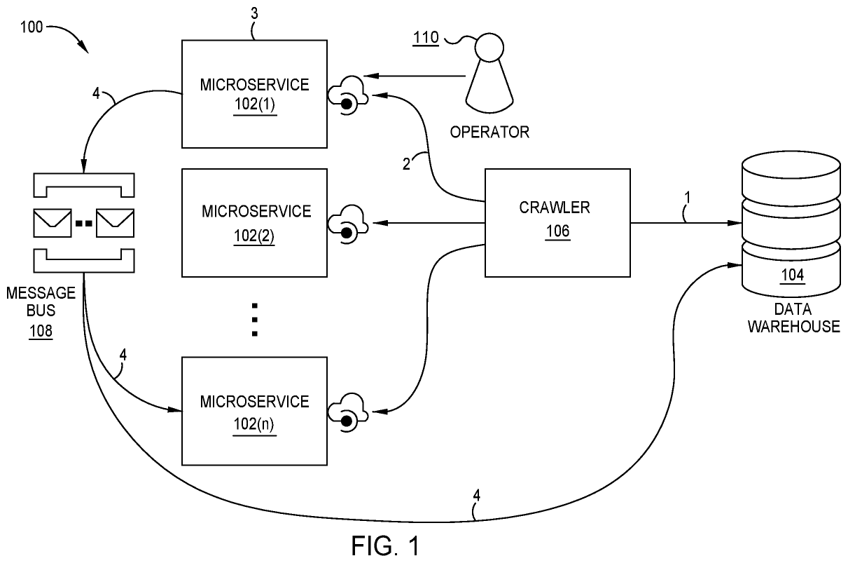

FIG. 1 depicts an example schematic architecture for validation and reconciliation of data in a DWH with which embodiments of the present disclosure may be implemented.

In virtual machine (VM)-based computing architecture, multiple instances of VMs execute on a physical host, which includes hardware such as a processor, memory, storage, network interface card, etc. The memory may store instructions that when executed by the processor cause the processor to perform techniques described herein. Each VM instance runs its own copy of an operating system (OS) in which one or more application/service instances execute. Alternatively, container-based computing architecture is another type of computing solution. Unlike traditional VM-based architecture, in a container-based computing architecture, a single instance of an OS supports multiple containers in a single physical host. A single microservice can be implemented using multiple instances of containers, VMs, or other virtual computing instances (VCIs) that are not necessarily on the same host. Though certain techniques are described with respect to microservices running in containers, it should be noted that such techniques may also be applicable to other types of VCIs or even physical computing devices.

Containers and/or other VCIs support certain microservices. A microservice can have more than one corresponding instance (e.g., multiple processes) executing on more than one VCI or physical computing device. In an example, an instance of a microservice executes within a container. The execution of an instance of a microservice is supported by physical resources such as one or more processors and one or more memories. The number of VCIs and/or containers on each host device, the number of host devices, and the distribution of VCIs and/or containers and microservices are configurable.

In certain embodiments, a container or other VCI type provides support for the microservice, such as interfacing the microservice with OS facilities such as memory management, file system, networking, input/output (I/O), etc. Unlike traditional VMs, a container does not need to run a complete OS; rather, multiple containers share an OS kernel installed within an OS. The kernel manages the containers, provides resource sharing, and interfaces between the containers and the rest of the OS on the physical device, providing a layer of abstraction to the containers. The kernel makes it appear as though each container were running in isolation relative to other containers by facilitating system resources sharing amongst the containers.

A “microservice” is a type of service. The microservice architectural style is an approach to developing a single application as a suite of small microservices, each running in its own process and communicating with lightweight mechanisms, such as application programming interfaces (APIs). In some embodiments, microservices are reusable self-contained entities which may help to improve the development, maintenance, and lifecycle of an application more effectively.

As shown in FIG. 1, any number of microservices 102(1)-(n) (each individually referred to herein as microservice 102 and collectively referred to herein as microservices 102) configured to execute within a computing infrastructure (e.g., a container-based computing infrastructure) are deployed. Microservices 102 may be built for organization capabilities, and in certain embodiments, each microservice 102 performs a single function. As mentioned previously, in certain embodiments, each microservice 102 owns its own data and its own domain logic (e.g., rules for determining how data may be created, stored, and/or changed at the microservice 102). In particular, in certain embodiments, data owned by each microservice 102 is private to that microservice 102 and can only be accessed via its application programming interface (API). In some cases, data owned by each microservice 102 is maintained in an SOR associated with that microservice 102. An SOR is an information storage system that is the authoritative data source for a microservice 102.

However, the modern data paradigm depends on centralization. For example, to facilitate analytics and ad-hoc querying, data needs to be gathered from the microservices 102 and stored in a central data repository. One such central data repository may be a DWH, such as DWH 104 shown in FIG. 1.

DWH 104 is a storage, such as a database system. In some embodiments, DWH 104 is a scalable relational database system offering a structured query language (SQL) for offline analysis of data. DWH 104 may be loaded periodically, e.g., nightly or weekly, with data ingested from various sources, such as operational systems. As shown in the example of FIG. 1, data ingested by DWH 104 may be data from microservices 102. The process of cleaning, curating, and unifying this data into a single schema and loading it into DWH 104 is known as extract, transform, load (ETL). As the variety of sources and data increases, the complexity of the ETL process also increases.

In some cases, event-driven ETLs may be used for data integration into DWH 104. In particular, event-driven ETLs offer an alternative approach to periodic batch processing, removing the need for fixed interval runs by operating in a more reactive manner, by allowing changes in each data source, e.g., each microservice 102, to trigger data processing. An event may be defined as “a significant change in state”. For example, when a consumer purchases a couch, the couch's state changes from “for sale” to “sold”. A furniture store's system architecture may treat this state change as an event whose occurrence can be made known to other microservices 102, or DWH 104, within the architecture.

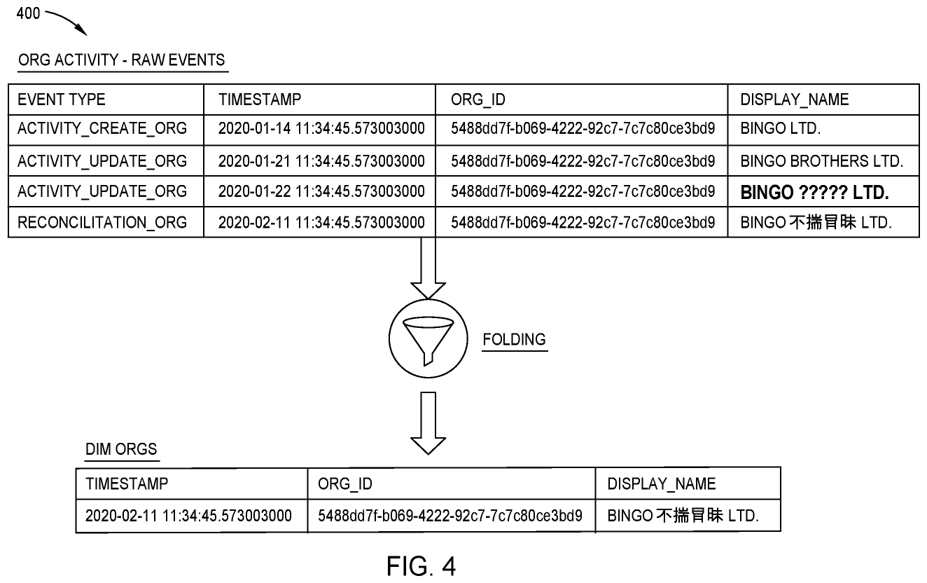

An event may include one or more parts, such as two parts: the event header and the event body. The event header may include information such as the type of event, a timestamp for the event, and/or an identifier (ID) of the microservice where the event was created (e.g., organization ID). In an example, events may include creating, updating, or deleting (CUD) operations, such that each event has a corresponding event type that contains values of either “create”, “update”, or “delete”. The event body provides the details of the state change detected. Example events are illustrated with respect to FIG. 4.

In certain embodiments, events are issued when a specific event happens at each microservice 102 and are subsequently published to DWH 104. Events received at DWH 104 may be used to create, update, and/or delete data stored in DWH 104, and each of these events may be stored in sequential order according to a schema of the DWH. As mentioned previously, events in DWH 104 may be stored according to a star schema. In particular, CUD events may constitute the dimensions tables of the star schema such that rows are added to the tables each time an event at each microservice 102 occurs and is published to DWH 104.

According to certain aspects of the present disclosure, a crawler 106 is introduced to periodically query record(s) from DWH 104 for the purpose of validation and reconciliation. A crawler is capable of crawling multiple data stores in a single run, and in the context of this application, data stored in DWH 104. In particular, crawler 106 may query chunks of data in DWH 104, each chunk belonging to one or more microservices 102 (referred to herein as owner microservices 102 in that they own/created the data of the chunk). A chunk may include one or more records belonging to one or more microservices 102 which originally generated the record(s). Where chunks are retrieved having records belonging to multiple owner microservices 102, a mapping is maintained between the fields in each record in the chunk and its owner microservice 102.

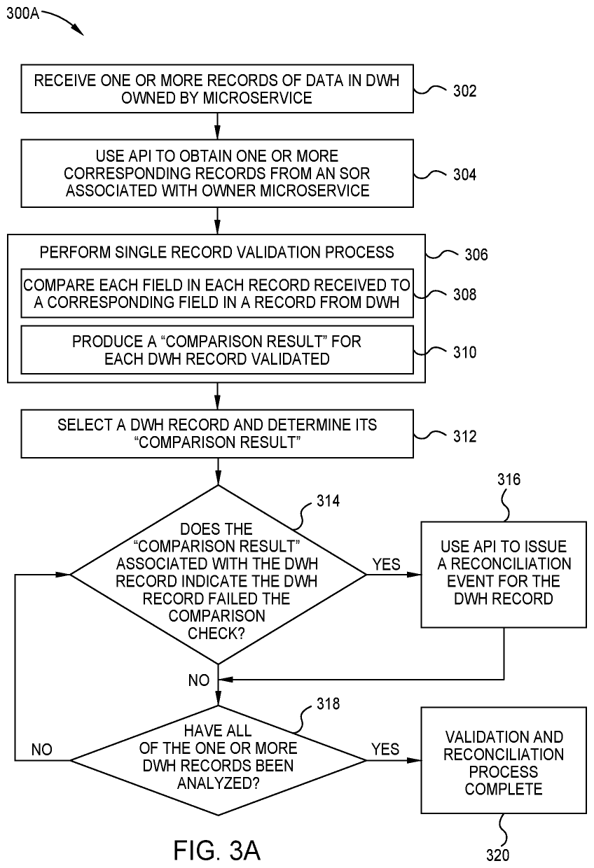

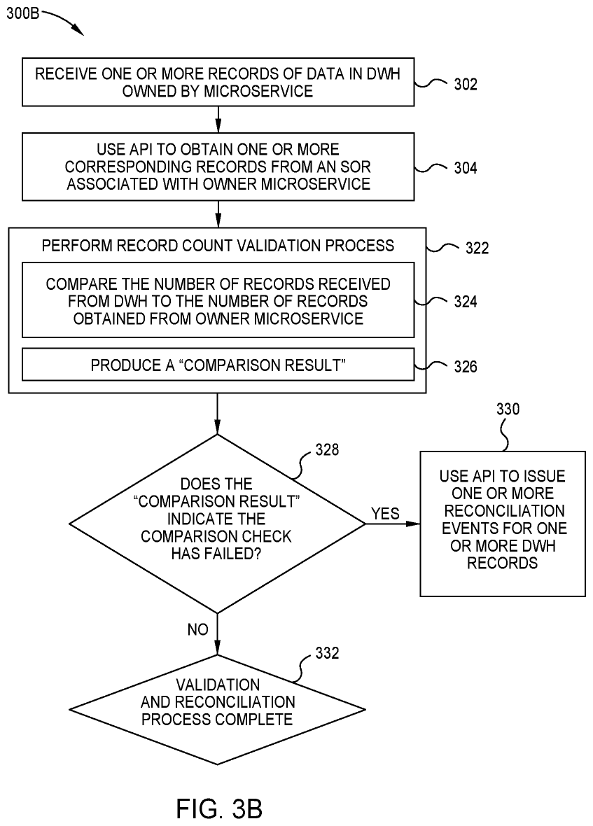

Crawler 106 may transmit such records/chunks to their corresponding owner microservice 102 for validation and reconciliation. Microservices 102 perform data validation of data in DWH 104 to determine whether reconciliation is necessary. Two example validation processes performed by microservices 102 include (1) single record validation and (2) record count validation, described in more detail with respect to FIGS. 3A and 3B, respectively. Different implementations of crawler 106 may be considered based on the validation process to be performed by each of microservices 102. Although FIG. 1 illustrates crawler 106 external to each of microservices 102, in some cases, crawler 106 is part of each microservice 102. Crawler 106 may run on one or more suitable VCIs and/or physical computing devices.

Crawler 106 and microservices 102 may be configured to perform data validation and reconciliation to detect discrepancies between data stored in DWH 104 and data stored in an SOR associated with each microservice 102 to remediate such discrepancies when detected by crawler 106. As shown in FIG. 1, data validation and reconciliation performed by crawler 106 and microservices 102 may comprise four steps to get one or more records from DWH 104 and one or more microservices 102, verify one or more records, and trigger reconciliation, if necessary. In particular, at a first step, crawler 106 identifies (e.g., randomly) a validation set that contains a subset of one or more records from DWH 104 and queries such records from DWH 104. The queried records may belong to one or more owner microservices 102, and at a second step, crawler 106 passes the queried one or more records to their respective owner microservice(s) 102, and more specifically, to the remediation APIs of each owner microservice 102. The remediation API of each owner microservice 102 retrieves corresponding records (e.g., from an SOR corresponding to the microservice 102) to compare against the records queried from DWH 104. Thus, at a third step, the remediation API of each owner microservice 102 produces “comparison result” record(s) by comparing the one or more records. The “comparison result” record(s) may indicate whether discrepancies exist between record(s) in DWH 104 and each microservice 102. Upon detecting discrepancies among the one or more records, at a fourth step, microservice(s) 102 may issue reconciliation event(s) to DWH 104, as well as other microservice(s) with an interest in the record(s) being remediated (also referred to herein as subscriber microservices 102 in that they subscribe to or use the data of the record). The reconciliation event(s) may be transmitted through a message bus 108. In certain embodiments, a message bus 108 is a messaging infrastructure that allows different microservices 102 to communicate through a shared set of interfaces. The reconciliation event(s) may remediate record(s) of data in subscriber microservices 102, as well as record(s) maintained in DWH 104. This validation and reconciliation process is described in more detail below with respect to FIGS. 3A and 3B.

In some cases, as shown in FIG. 1, an operator 110 (e.g., administrator, user, etc.) calls a remediation API of each microservice 102 to identify and reconcile any missing data. For example, manual manipulation (e.g., modification and deletion) of data stored in a database associated with a microservice 102 may not trigger an event to be issued and published to DWH 104. Accordingly, in order to ensure consistency of data among microservice 102 and DWH 104, operator 110 may manually trigger reconciliation. In particular, operator 110 may trigger microservice 102 to issue a reconciliation event to remediate record(s) of data in DWH 104. In some cases, the reconciliation event may also remediate record(s) of data in subscriber microservices 102. Operator 110 may call a remediation API to create, update, or delete information of specific records or records with a corresponding timestamp between a specified start and end time and date.

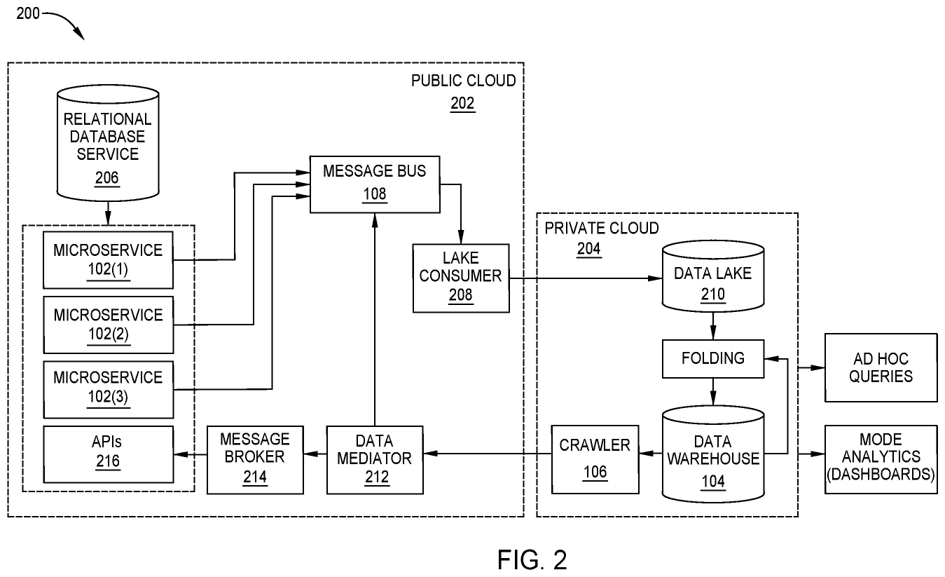

FIG. 2 depicts example virtual components of a computing environment 200 with which embodiments of the present disclosure may be implemented. In particular, FIG. 2 is a particular implementation in which the validation and reconciliation process of FIG. 1 may be performed. As shown in FIG. 2, microservices 102, DWH 104, and crawler 106 of FIG. 1 may be distributed across a hybrid cloud for performing data validation and reconciliation. A hybrid cloud is a type of cloud computing that combines on-premises infrastructure, e.g., a private cloud 204 comprising one or more physical computing devices (e.g., running one or more VCIs) on which the processes shown run, with a public cloud 202 comprising one or more physical computing devices (e.g., running one or more VCIs) on which the processes shown run. Hybrid clouds allow data and applications to move between the two environments. Many organizations choose a hybrid cloud approach due to organization imperatives such as meeting regulatory and data sovereignty requirements, taking full advantage of on-premises technology investment, or addressing low latency issues.

As shown in FIG. 2, microservices 102 may be deployed in public cloud 202, while DWH 104 and crawler 106 may be deployed in private cloud 204. Each microservice 102 may persist their data in a database, such as a relational database provided by relational database service (RDS) 206. In certain embodiments, the relational database provided by RDS 206 organizes data into tables which can be linked—or related—based on data common to each. This capability enables the retrieval of an entirely new table from data in one or more tables with a single query. In certain embodiments, the relational database stores data in tabular form with columns and rows, and can be queried using structure query language (SQL). Further, data in the relational database may be marked with an identifier to differentiate data of one microservice 102 from data of another microservice 102. While FIG. 2 illustrates a relational database shared by microservices 102, in some other implementations, other types of databases, such as non-relational, NoSQL, or NewSQL databases may be used by microservices 102 to persist their data.

Each microservice 102 may be responsible for exposing data integrity driven APIs, shown as APIs 216, for data validation and reconciliation. APIs 216 may be used as a communication interface to receive one or more records from DWH 104. In particular, crawler 106 may periodically query one or more records from DWH 104 which may be passed through a data mediator 212 and a message broker 214 to microservices 102 through APIs 216. In certain embodiments, data mediator 212 performs data mediation, which is the semantic transformation of data structure and data content to establish semantic equivalence of different representations. Semantic transformation is the process of using semantic information to aid in the translation of data in one representation or data model to another representation or data model. In certain embodiments, message broker 214, also referred to as hub-and-spoke architecture, is a software module configured to translate messages between formal messaging protocols. Message broker 214 allows interdependent components to “talk” with one another directly, even where they are written in different languages or implemented on different platforms. In other words, message broker 214 allows crawler 106 to communicate with microservices 102 for the purpose of data validation and reconciliation.

As mentioned previously, microservices 102 may publish events to DWH 104. Events may include CUD events when a specific event happens at a microservice 102 or reconciliation events when a microservice 102 recognizes missing or corrupted data in DWH 104. Microservices 102 may use a message bus 108 to publish such events to DWH 104. In certain embodiments, message bus 108 is a combination of a common data model, a common command set, and a messaging infrastructure to allow different components in cloud environment 200 to communicate through a shared set of interfaces.

In certain embodiments, a lake consumer 208 may be configured to gather events from message bus 108 and store the events, as raw data, in data lake 210. Raw data is data that has not yet been processed for a purpose. Data lake 210 may be implemented in private cloud 204. In certain embodiments, data lakes store unfiltered and unprocessed data in its native format. Accordingly, in this implementation, data lake 210 stores events published by microservices 102 in their native format.

Data from data lake 210 which has been processed for a specific purpose may be stored in DWH 104. In other words, events in data lake 210 may be used to create, update, delete, or reconcile data in DWH 104. Reconciliation of data in DWH 104 may be performed by “folding” an event on top of events originally published to DWH 104 to correct the data in DWH 104. Reconciliation, and more specifically “folding”, are described in more detail with respect to FIG. 4.

As shown in FIG. 2, centralizing data from each microservice 102 in DWH 104 may facilitate in analysis and ad-hoc querying. For example, a dashboard may be configured to query data from DWH 104 for transformation into a series of charts, graphs, and/or other visualizations that update in real time. Dashboards may provide an at-a-glance update on the metrics and key performance indicators (KPIs) that matter most to an organization.

FIG. 3A is an example workflow 300A for single record validation and reconciliation, according to an example embodiment of the present application. As mentioned herein, two validation processes that may be performed by microservices 102 include (1) single record validation and (2) record count validation. When performing single record validation, microservices 102 are responsible for validating the correctness of a record itself. In other words, microservices 102 may compare fields of a record in DWH 104 to fields of a record stored in an SOR associated with each microservice 102. Fields are the individual parts that contain information about the record. As an example, a record maintained in DWH 104 and a record maintained in an SOR associated with a microservice 102 may contain information about a person, including a person's name, address, and/or phone number. The person's name, address, and phone number may be represented as fields in the records for the person maintained by DWH 104 and the SOR. Thus, when performing single record validation, microservice 102, which owns the record for the person, may compare the person's name in the record stored in the SOR against the person's name in the record stored in DWH 104. Similar comparison may be performed for the remaining fields of the record, including the person's address and the person's phone number. This type of validation may be used to identify inaccurate or missing data (e.g., field values of records) stored in DWH 104 for the purpose of remediation.

Validation workflow 300A of FIG. 3A may be performed by microservices 102 illustrated in FIGS. 1 and 2. In particular, one or more records obtained from DWH 104 may be compared against corresponding one or more records owned by one or more microservices 102. For ease of explanation, validation workflow 300A of FIG. 3A may concern the validation of multiple records from DWH 104 owned by a single microservice 102. However, in some other implementations, multiple records from DWH 104 owned by multiple microservices 102 may be validated at one time.

As shown in FIG. 3A, validation workflow 300A begins at block 302 by microservice 102 receiving one or more records of data in DWH 104 that are owned by microservice 102. In particular, microservice 102 receives the one or more records of data from a crawler, such as crawler 106 illustrated in FIGS. 1 and 2. As mentioned previously, crawler 106 is configured to query chunks of data in DWH 104, each chunk belonging to one or more microservices 102 (referred to herein as owner microservices 102). A chunk may include one or more records belonging to one or microservices 102 which originally generated the record. For this example, it may be assumed that crawler 106 obtains one or more records belonging to a single microservice 102, and communicates these one or more records to the owner microservice 102. Crawler 106 may use an API associated with owner microservice 102 for communicating these one or more records to owner microservice 102.

In certain embodiments, crawler 106 is configured to query DWH 104 according to a preconfigured schedule, a preconfigured batch size, or both. A preconfigured schedule may indicate a threshold amount of time for which crawler 106 is to wait before querying data from DWH 104. The threshold amount of time may be defined in seconds, minutes, hours, etc. A preconfigured batch size may indicate the number of records crawler 106 is to retrieve from DWH 104 each time a query is performed on DWH 104. For example, records in DWH 104 may be organized according to their corresponding timestamp. Crawler 106 may be configured to select the top “s” records organized according to their corresponding timestamp, where “s” is an integer equal to or greater than one and represents the size of the batch to be validated (e.g., the size of the batch to be retrieved by crawler 106 from DWH 104).

After receiving such records, at block 304, owner microservice 102 uses its corresponding API to retrieve one or more records corresponding to the one or more records received from DWH 104. Owner microservice 102 may retrieve such corresponding records from an SOR associated with owner microservice 102.

In some cases, the API retrieves one or more records from the SOR according to set parameters. In some examples, the parameters indicate a start date and an end date. The start date and end date may be used to limit the number of records retrieved from the SOR, and more specifically limit the records retrieved from SOR to be records with an “updated” timestamp (e.g., “updated_at” timestamp) or “created” timestamp (e.g., “created_at” timestamp) where a record has not been updated between the specified start date and the specified end date. An “updated” timestamp may indicate when the record in the SOR was most recently updated, while a “created” timestamp may indicate when the record in the SOR was created. In some cases, only records that have been recently updated may be desired, thus, the API may retrieve the one or more records according to their updated timestamp. In some other examples, the parameters may indicate a page start and a page limit to limit the number of records retrieved from the SOR based on a maximum threshold amount of pages. In either example, the API may accept the parameters to narrow the number of records retrieved from the SOR based, at least in part, on the parameters.

In some cases, the API retrieves one or more records from the SOR according to specific record IDs. For example, in some cases, an operator, such as operator 110 illustrated in FIG. 1, may recognize one or more missing or corrupted records in DWH 104. Accordingly, operator 110 may identify record IDs of these missing or corrupted records and indicate to owner microservice 102 of such records, these record IDs. Accordingly, the API associated with that owner microservice 102 may use the indicated record IDs to determine which corresponding records to retrieve from the SOR for validation and reconciliation.

In some cases, the API works in a separate, less prioritized thread pool to ensure that the retrieval of one or more records for validation does not does not affect mission critical tasks of microservice 102. A thread is a small set of instructions designed to be scheduled and executed, while a thread pool uses previously created threads to execute current tasks. In other words, to ensure mission critical tasks, e.g., tasks that are indispensable to continuing operations, are carried out, a thread for record retrieval is assigned a lower priority than a thread for a mission critical task to be performed by microservice 102.

At block 306, owner microservice 102 performs single record validation. In particular, at block 308, owner microservice 102 compares fields of the records received from crawler 106 at block 304 against fields of the records obtained from the SOR at block 306. For example, assuming owner microservice 102 received three records containing information for three different consumers of a company, the records containing fields related to the consumer's name, the consumer's address, and the consumer's phone number, owner microservice 102 would have also obtained three records corresponding to each of these three different consumers from the SOR associated with microservice 102. Accordingly, owner microservice 102 may compare the first consumer's name field in the first record received from DWH 104 with the first consumer's name field in the first record retrieved from the SOR, the first consumer's address field in the first record received from DWH 104 with the first consumer's address field in the first record retrieved from the SOR, and the first consumer's phone number field in the first record received from DWH 104 with the first consumer's phone number field in the first record retrieved from the SOR. Similar comparisons may be performed for the second and third record, for the second and third consumer, from each of DWH 104 and the SOR.

At block 310, owner microservice 102 produces a “comparison result” for each DWH record validated. In other words, owner microservice 102 produces a “comparison result” by comparing each feature in each record from DWH 104 to its corresponding feature in a record from the SOR. For example, in the illustrative example introduced above, owner microservice 102 produces three “comparison results”, e.g., a first comparison result for the comparison of the features in the records associated with the first consumer, a second comparison result for the comparison of the features in the records associated with the second consumer, and a third comparison result for the comparison of the features in the records associated with the third consumer.

The “comparison result” may be a record generated by microservice 102 including the following information: (1) the validation type, (2) the record ID(s), (3) a score based on a number of detected discrepancies divided by the total number of fields analyzed in each record pair (e.g., record from DWH and record from the SOR) being compared, and/or (4) field value mismatches. As mentioned previously, the validation type may be (1) single record validation or (2) record count validation performed by microservice 102. The record ID may be the ID(s) of the records compared, e.g., the record ID associated with the record from DWH 104 and the record ID associated with the record from the SOR. In some cases, these record IDs may be same, while in other cases these record IDs may be different. The score may be calculated according to the following equation:

$$Score = 100 - \frac{\vert Number of Detected discrepancies \vert * 100}{\vert Number of Record fields \vert}$$

where the number of records fields is the number of fields analyzed in the records being compared for the record pair, and the number of detected discrepancies is the number of fields compared where field values in the DWH 104 record were invalid (e.g., “Null” value), inaccurate, missing information, etc. A record pair may be assigned a score ranging between 0 and 100. Accordingly, record pairs without any discrepancy will receive a score of 100, while record pairs with only invalid/inaccurate fields (e.g., except record IDs) will receive a score of 0. Field value mismatches may explicitly identify fields in the DWH 104 record of the record pair where the value for the field does not match the value for the field in the SOR record. While the calculated score also takes into consideration these field value mismatches, the field value mismatch information is explicitly identified to allow microservice 102 to determine whether reconciliation is required. In some cases, a field value mismatch may always trigger reconciliation by microservice 102.

In the illustrative example introduced above, a “comparison result” is produced for each record pair associated with each of the three consumers. In other words, three “comparison results” are produced, each “comparison result” indicating a validation type, the record IDs of the records in the record pair being compared, a score, and a number of field value mismatches. For the first record pair associated with the first consumer, the validation type in the “comparison result” indicates single record validation was performed and further includes the record IDs of the first record associated with the first consumer from DWH 104 and the record ID of the first record associated with the first consumer from the SOR. For the score and the number of field value mismatches, in this example, it may be assumed that the first record from DWH 104 includes a misspelled name for the first consumer in the consumer name field of the record, a correct address for the first consumer in the consumer address field of the record, and an indication of an invalid phone number for the first consumer in the consumer phone number filed of the record. Accordingly, the number of detected discrepancies is equal to two to account for the misspelled name and the invalid phone number while the number of record fields is equal to three to account for the consumer name field, the consumer address field, and the consumer phone number field. Thus, the calculated score indicated in this “comparison result” record is a score of approximately

$$33 ( Score = 100 - \frac{\vert 2 \vert * 100}{\vert 3 \vert} = 100 - 66.667 = 33.333 ) .$$

The number of field value mismatches indicated in the record may be equal to two in order to account for the misspelled name of the first consumer in the consumer name field of the DWH 104 associated with the first consumer. Information for “comparison result” records generated for each of the second and third record pair are determined in a similar manner as the information for the “comparison result” record generated for the first record pair.

At block 312, microservice 102 selects a DWH 104 record and determines its associated “comparison result” produced at block 310. For example, microservice 102 selects one of the three DWH 104 records, which each belong to one of the three record pairs having an associated “comparison result”. While it may be assumed that microservice 102 selects the first DWH 104 record associated with the first consumer, in some other examples, microservice 102 selects the second DWH record associated with the second consumer or the third DWH 104 record associated with the third consumer. As mentioned, the first DWH 104 record associated with the first consumer contains a score of approximately 33 and a number of field value mismatches equal to one.

At block 314, microservice 102 determines whether the “comparison result” associated with the DWH 104 record indicates the DWH 104 record failed the comparison check. Microservice 102 makes this determination based on at least the score, the number of field value mismatches, or both indicated in the “comparison result”. For example, the microservice 102 may compare the score to a threshold, and if the score is below the threshold, determine the DWH 104 record failed the comparison check, and if the score is above the threshold, determine the DWH 104 record passed the comparison check. Thus, in the illustrative example, microservice 102 makes this determination based on the “comparison result” associated with the DWH 104 record for the first consumer indicating a score of approximately 33 and a number of filed value mismatches equal to one.

Where, at block 314, microservice 102 determines the “comparison result” associated with the DWH 104 record indicates the DWH 104 record failed the comparison check, at block 316, microservice 102 issues a reconciliation event, using its associated API, to remediate the record in DWH 104. The reconciliation event, in this example, includes two fields: a reconciliation header and a reconciliation originator. The reconciliation originator contains the metadata and other fields that that represent the record in DWH 104 to be corrected. How a reconciliation event is used to remediate one or more records maintained by DWH 104 is described in more detail with respect to FIG. 4.

In some cases, the reconciliation event is initially received by a reconciliation controller. The reconciliation controller determines whether the event will be published or not. A default value of “true” indicates that the reconciliation event won't be published to DWH 104.

Further, in some cases, the reconciliation event is published not only to remediate a record in DWH 104, but also a record in a subscriber microservice 102. As mentioned herein, subscriber microservices 102 may have an interest in the record(s) being remediated; thus, the reconciliation event may also be published to each of these subscriber microservices 102. For example, in the illustrated example introduced above, a reconciliation event is issued for the first record in DWH 104 to correct a spelling of the first consumer's name in the record maintained by DWH 104 for the first consumer. Other microservices 102, e.g., subscriber microservices 102, may also have record(s) with field(s) having consumer names, and in particular, at least one record having a field corresponding to the first consumer's name. Accordingly, a reconciliation event is published to this microservice to also correct the name of the first consumer in a record maintained by this microservice. In other words, a reconciliation event published to a subscriber microservice 102 informs the subscriber microservice 102 about the change such that they may fix the information contained in one or more records maintained by that subscriber microservice 102.

Subsequent to issuing a reconciliation event to remediate data for a DWH 104 record, at block 318, microservice 102 determines whether all of the one or more DWH records have been analyzed. Additionally, where, at block 314, microservice 102 determines the “comparison result” associated with the DWH 104 record indicates the DWH 104 record has not failed (e.g. passed) the comparison check, at block 318, microservice 102 determines whether all of the one or more DWH records have been analyzed. In other words, to ensure remediation of all necessary data in one or more records maintained by DWH 104 (and in some cases, one or more records maintained by subscriber microservices 102), microservice 102 analyzes each of the produced “comparison result” records. For example, in the illustrative example introduced above, at block 318, microservice 102 has only analyzed a “comparison result” produced for the first DWH 104 record associated with the first consumer, while the “comparison result” produced for the second DWH 104 record associated with the second consumer and the “comparison result” produced for the third DWH 104 record associated with the third consumer have not been analyzed. Accordingly, DWH 104 returns to block 312 for each to determine whether a reconciliation event is needed to remediate information associated with each of these records for the second consumer and the third consumer maintained in DWH 104.

Alternatively, where, at block 318, microservice 102 determines all DWH 104 records (and their corresponding “comparison results”) have been analyzed, at block 320, the validation and reconciliation process is determined to be complete. Workflow 300A may be performed each time crawler 106 is scheduled to query data (e.g., one or more records) from DWH 104 and/or an operator, such as operator 110 of FIG. 1, initiates validation workflow 300B.

FIG. 3B is an example validation workflow 300B for record count validation and reconciliation, according to an example embodiment of the present application. As mentioned herein, two validation processes performed by microservices 102 include (1) single record validation and (2) record count validation. When performing record count validation, microservices 102 are responsible for validating that DWH 104 is not missing any records, validating that DWH 104 does not contain any irrelevant records, or a combination of both. Irrelevant records may be records which originated from a microservice 102 that no longer exists or records which originated from a microservice 102 that has since deleted the record in its associated SOR.

Validation workflow 300B of FIG. 3B may be performed by microservices 102 illustrated in FIGS. 1 and 2. In particular, a sample number of records obtained from DWH 104 may be compared against corresponding records owned by one or more microservices 102. For ease of explanation, validation workflow 300B of FIG. 3B concerns the validation of multiple records from DWH 104 owned by a single microservice 102. However, in some other implementations, multiple records from DWH 104 owned by multiple microservices 102 may be validated at one time.

Similar to validation workflow 300A shown in FIG. 3A, validation workflow 300B begins at block 302 by microservice 102 receiving one or more records of data in DWH 104 that are owned by microservice 102. Further, at block 304, owner microservice 102 uses its corresponding API to retrieve one or more records corresponding to the one or more records received from DWH 104. Owner microservice 102 may retrieve such corresponding records from an SOR associated with owner microservice 102.

However, unlike validation workflow 300A which illustrates example operations for performing single record validation, at block 322 in FIG. 3B, owner microservice 102 performs a record count validation process. In particular, at block 324 owner microservice 102 compares the number of records received from DWH 104 (e.g., received from crawler 106) to the number of records obtained from the SOR associated with owner microservice 102. At block 326 owner microservice 102 produces a “comparison result” record for the comparison. In this case, the “comparison result” record indicates (1) the number of records received from DWH 104 is equal to the number of records obtained from the SOR, (2) the number of records received from DWH 104 is greater than the number of records obtained from the SOR, or (3) the number of records received from DWH 104 is less than the number of records obtained from the SOR. A number of records received from DWH 104 greater than the number of records obtained from the SOR may indicate to microservice 102 that DWH 104 contains one or more records that were either previously deleted by microservice 102. A number of records received from DWH 104 less than the number of records obtained from the SOR may indicate to microservice 102 that one or more records were never published to DWH 104.

As an illustrative example, where records in DWH 104 are organized according to their corresponding timestamp, and crawler 106 is configured to query records according to a start time and date of 9:00 am, Monday, August 3^{rd} and an end time and date of 9:00 am, Tuesday, August 4^{th}, crawler may query twenty records during this time period which were originated by owner microservice 102. Using its API, owner microservice 102 also queries the SOR associated with owner microservice 102 to retrieve records with a timestamp occurring between this start time and date and end time and date. For illustrative purposes, it may be assumed that owner microservice 102 obtains nineteen records having a timestamp between this start time and date and end time and date. Given the number of records queried from DWH 104 (e.g., twenty) is greater than the number of record obtained from the SOR (e.g., nineteen), owner microservice 102 determines that DWH 104 contains at least one record that was originally published to DWH 104 and has since been deleted by owner microservice 102 in its corresponding SOR.

While FIG. 3B is explained with respect to records queries for only one owner microservice 102, in some other cases records may be queried for multiple microservices 102. In this case, a comparison result may further indicate that one or more records in DWH 104 originated from a microservice 102 that no longer exists. For example, where crawler 106 queries all records of DWH 104 and determines this number of queried records is greater than a total number of records aggregated across each of the SORs corresponding to each of the microservices 102, microservices 102 may determine that the additional records in DWH 104 correspond to a microservice 102 that no longer exists. Microservices 102 make this determination after determining that microservices 102 had not deleted any records previously published to DWH 104.

At block 328, owner microservice 102 determines whether the “comparison result” indicates the comparison check has failed. A comparison check is said to have failed where the produced “comparison result” at block 326 indicates (1) the number of records received from DWH 104 is greater than the number of records obtained from the SOR or (2) the number of records received from DWH 104 is less than the number of records obtained from the SOR.

Where, at block 328, owner microservice 102 determines the “comparison result” indicates the comparison check has failed, at block 330, owner microservice 102 issues one or more reconciliation events, using its associated API, to remediate one or more records in DWH 104. In particular, where the number of records received from DWH 104 is greater than the number of records obtained from the SOR, the reconciliation event is issued to delete the additional one or more records in DWH 104. Further, the reconciliation event issued by microservice 102 may include a special flag indicating that the corresponding record in SOR was previously deleted. Alternatively, where the number of records received from DWH 104 is less than the number of records obtained from the SOR, the reconciliation event is issued to create one or more records missing from DWH 104. As mentioned previously, in some cases, the reconciliation event may be issued to not only DWH 104, but also subscriber microservices 102 to delete or create one or more records in their corresponding SORs.

Where, at block 328, owner microservice 102 determines the “comparison result” indicates the comparison check has not failed (e.g., passed), at block 332, the validation and reconciliation process is determined to be complete. Validation workflow 300B may be performed each time crawler 106 is scheduled to query data (e.g., one or more records) from DWH 104 and/or an operator, such as operator 110 of FIG. 1, initiates validation workflow 300B.

While FIGS. 3A and 3B illustrate single record validation and record count validation as two separate workflows that are performed by microservice(s) 102, in some cases, microservice(s) 102 performs both single record validation and record count validation at a same time for a same sample of records queries from DWH 104 by crawler 106.

FIG. 4 illustrates an example reconciliation event for remediation of a record in a DWH, according to an example embodiment of the present application. As shown in FIG. 4, raw events issued by each of microservices 102 are issued first to a data lake, such as data lake 210 described with respect to FIG. 2. The events may be CUD events for one or more records maintained in a DWH, such as DWH 104 described with respect to FIGS. 1 and 2. Events may also be reconciliation events issued for one or more records maintained in DWH 104. Further each event may be maintained with a corresponding timestamp such that there is record of when each event was issued to DWH 104. Maintaining events for each record in DWH 104 may help to identify why one or more discrepancies exist with records maintained by DWH 104. For example, where DWH 104 does not contain a “create” event for a record that was created in a microservice 102 and issued to DWH 104, this indicates that subsequent to microservice 102 issuing the “create” event, the system experienced one or more problems which caused the record not to be created in DWH 104.

As shown in the illustrative example of FIG. 4, an event to create a record for “Bingo LTD.” was issued to DWH 104 on Jan. 14, 2020. Subsequent to the creation of this record in DWH 104, two events to update the record were issued to DWH 104. The first update event was issued on Jan. 21, 2020 to update the record feature, “display_name”, from “Bingo LTD.” to “Bingo Brothers LTD.”. The second update event was issued on Jan. 22, 2020 to again update the same record feature; however, due to one or more various reasons, the request did not accurately indicate what the record feature, “display_name”, for “Bingo Brothers LTD.” was to be updated to.

Using the single record validation process depicted in validation workflow 300A of FIG. 3A, an owner microservice 102 detects that this record maintained in DWH 104 contains inaccurate/missing information for the feature “display_name”. Accordingly, owner microservice 102 issues a reconciliation event to correct the record feature, “display_name”, in the record maintained by DWH 104. As shown in FIG. 4, microservices 102 issues a reconciliation event on Feb. 11, 2020 after realizing the discrepancy. The reconciliation event is used to update the “display_name” feature to its accurate value (e.g., the accurate value shown in FIG. 4). In particular, the reconciliation event may be “folded” on top of the previous activity events (e.g., the create event and the two update events) to correct the value of the feature for this particular record to its intended value, such that the record maintained in DWH 104 is consistent with the record maintained in owner microservice 102.

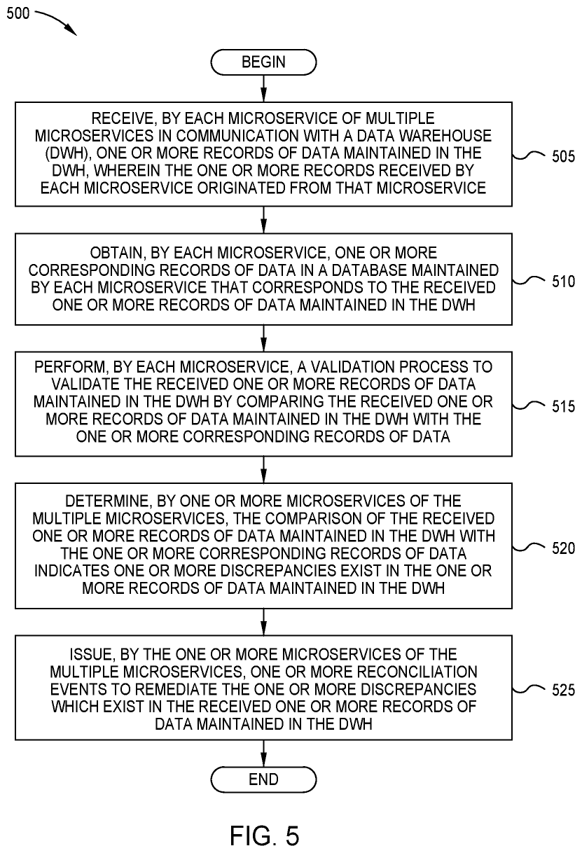

FIG. 5 is a flowchart illustrating a method (or process) 500 for data validation and reconciliation of data stored in a DWH, according to an example embodiment of the present application. In certain embodiments, process 500 may be performed by multiple microservices in communication with the DWH. For example, process 500 may be performed by microservices 102 in communication with DWH 104 as shown in FIGS. 1 and 2.

Process 500 may begin, at block 505, by each microservice of the multiple microservices, receiving one or more records of data maintained in the DWH, wherein the one or more records received by each microservice originated from that microservice. In certain embodiments, each microservice of the multiple microservices receives the one or more records maintained in the DWH from a crawler that queries the one or more records according to at least one of a preconfigured schedule or a batch size. In certain embodiments, the one or more records are received from the crawler through a message broker that translates the one or more records to its respective microservice where the one or more records originated from.

At block 510, each microservice obtains one or more corresponding records of data in a database maintained by each microservice that corresponds to the received one or more records of data maintained in the DWH. In certain embodiments, the database maintained by each microservice comprises an SOR that is the authoritative data source for data generated by each microservice.

At block 515, each microservice performs a validation process to validate the received one or more records of data maintained in the DWH by comparing the received one or more records of data maintained in the DWH with the one or more corresponding records of data. In certain embodiments, each microservice compares one or more features of the received one or more records of data maintained in the DWH with one or more features of the one or more corresponding records of data. In certain embodiments, compares a number of the received one or more records of data maintained in the DWH with a number of the one or more corresponding records of data.

At block 520, one or more microservices of the multiple microservices determine the comparison of the received one or more records of data maintained in the DWH with the one or more corresponding records of data indicates one or more discrepancies exist in the one or more records of data maintained in the DWH. In certain embodiments, determining the comparison indicates one or more discrepancies exist in the one or more records of data maintained in the DWH includes determining at least one of inaccurate information or missing information exists in the one or more features of the received one or more records of data maintained in the DWH. In certain embodiments, determining the comparison indicates one or more discrepancies exist in the one or more records of data maintained in the DWH includes determining the number of the received one or more records of data maintained in the DWH is not equal to the number of the one or more corresponding records of data.

At block 525, the one or more microservices of the multiple microservices issue one or more reconciliation events to remediate the one or more discrepancies which exist in the received one or more records of data maintained in the DWH. In certain embodiments, the one or more microservices of the multiple microservices determines to issue the reconciliation event for a record of the one or more records of data maintained in the DWH based, at least in part, on a score calculated for the comparison, wherein the score is calculated based on: a number of features analyzed in the record maintained in the DWH and its corresponding record of the one or more corresponding records of data, and a number of features in the record maintained in the DWH that did not match a corresponding feature in the corresponding record.

The various embodiments described herein may employ various computer-implemented operations involving data stored in computer systems. For example, these operations may require physical manipulation of physical quantities usually, though not necessarily, these quantities may take the form of electrical or magnetic signals where they, or representations of them, are capable of being stored, transferred, combined, compared, or otherwise manipulated. Further, such manipulations are often referred to in terms, such as producing, identifying, determining, or comparing. Any operations described herein that form part of one or more embodiments may be useful machine operations. In addition, one or more embodiments also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments may be implemented as one or more computer programs or as one or more computer program modules embodied in one or more computer readable media. The term computer readable medium refers to any data storage device that can store data which can thereafter be input to a computer system computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), NVMe storage, Persistent Memory storage, a CD (Compact Discs), CD-ROM, a CD-R, or a CD-RW, a DVD (Digital Versatile Disc), a magnetic tape, and other optical and non-optical data storage devices. The computer readable medium can be a non-transitory computer readable medium. The computer readable medium can also be distributed over a network coupled computer system so that the computer readable code is stored and executed in a distributed fashion. In particular, one or more embodiments may be implemented as a non-transitory computer readable medium comprising instructions that, when executed by one or more processors of a computing system, cause the computing system to perform a method, as described herein.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and datastores are somewhat arbitrary, and particular operations are illustrated in the context of specific illustrative configurations. Other allocations of functionality are envisioned and may fall within the scope of one or more embodiments. In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s). In the claims, elements and/or steps do not imply any particular order of operation, unless explicitly stated in the claims.

We claim:

1. A method for data validation and reconciliation of data stored in a data warehouse (DWH) by multiple microservices in communication with the DWH, the method comprising:
receiving, by each microservice of the multiple microservices, one or more records of data maintained in the DWH, wherein the one or more records received by each microservice originated from that microservice;
obtaining, by each microservice, one or more corresponding records of data in a database maintained by each microservice that corresponds to the received one or more records of data maintained in the DWH;
performing, by each microservice, a validation process to validate the received one or more records of data maintained in the DWH by comparing the received one or more records of data maintained in the DWH with the one or more corresponding records of data;
determining, by one or more microservices of the multiple microservices, the comparison of the received one or more records of data maintained in the DWH with the one or more corresponding records of data indicates one or more discrepancies exist in the one or more records of data maintained in the DWH; and
issuing, by the one or more microservices of the multiple microservices, one or more reconciliation events to remediate the one or more discrepancies which exist in the received one or more records of data maintained in the DWH.

2. The method of claim 1, wherein each microservice of the multiple microservices receives the one or more records maintained in the DWH from a crawler that queries the one or more records according to at least one of a preconfigured schedule or a batch size.

3. The method of claim 2, wherein the one or more records are received from the crawler through a message broker that translates the one or more records to a format used by its respective microservice where the one or more records originated from.

4. The method of claim 1, wherein the database maintained by each microservice comprises a system of record (S OR) that is an authoritative data source for data generated by each microservice.

5. The method of claim 1, wherein comparing, by each microservice, the received one or more records of data maintained in the DWH with the one or more corresponding records of data obtained by each microservice comprises:
comparing one or more features of the received one or more records of data maintained in the DWH with one or more features of the one or more corresponding records of data; and
wherein determining the comparison indicates one or more discrepancies exist in the one or more records of data maintained in the DWH comprises determining at least one of inaccurate information or missing information exists in the one or more features of the received one or more records of data maintained in the DWH.

6. The method of claim 5, further comprising determining to issue, by the one or more microservices of the multiple microservices, a reconciliation event for a record of the one or more records of data maintained in the DWH based, at least in part, on a score calculated for the comparison, wherein the score is calculated based on:
a number of features analyzed in the record maintained in the DWH and its corresponding record of the one or more corresponding records of data, and
a number of features in the record maintained in the DWH that did not match a corresponding feature in the corresponding record.

7. The method of claim 1, wherein comparing, by each microservice, the received one or more records of data maintained in the DWH with the one or more corresponding records of data obtained by each microservice comprises:
comparing a number of the received one or more records of data maintained in the DWH with a number of the one or more corresponding records of data; and
wherein determining the comparison indicates one or more discrepancies exist in the one or more records of data maintained in the DWH comprises determining the number of the received one or more records of data maintained in the DWH is not equal to the number of the one or more corresponding records of data.

8. A system comprising one or more processors and a non-transitory computer readable medium comprising instructions that, when executed by the one or more processors, cause the system to perform a method for data validation and reconciliation of data stored in a data warehouse (DWH) by multiple microservices in communication with the DWH, the method comprising:
receiving, by each microservice of the multiple microservices, one or more records of data maintained in the DWH, wherein the one or more records received by each microservice originated from that microservice;
obtaining, by each microservice, one or more corresponding records of data in a database maintained by each microservice that corresponds to the received one or more records of data maintained in the DWH;
performing, by each microservice, a validation process to validate the received one or more records of data maintained in the DWH by comparing the received one or more records of data maintained in the DWH with the one or more corresponding records of data;
determining, by one or more microservices of the multiple microservices, the comparison of the received one or more records of data maintained in the DWH with the one or more corresponding records of data indicates one or more discrepancies exist in the one or more records of data maintained in the DWH; and
issuing, by the one or more microservices of the multiple microservices, one or more reconciliation events to remediate the one or more discrepancies which exist in the received one or more records of data maintained in the DWH.

9. The system of claim 8, wherein each microservice of the multiple microservices receives the one or more records maintained in the DWH from a crawler that queries the one or more records according to at least one of a preconfigured schedule or a batch size.

10. The system of claim 9, wherein the one or more records are received from the crawler through a message broker that translates the one or more records to a format used by its respective microservice where the one or more records originated from.

11. The system of claim 8, wherein the database maintained by each microservice comprises a system of record (S OR) that is an authoritative data source for data generated by each microservice.

12. The system of claim 8, wherein comparing, by each microservice, the received one or more records of data maintained in the DWH with the one or more corresponding records of data obtained by each microservice comprises:
comparing one or more features of the received one or more records of data maintained in the DWH with one or more features of the one or more corresponding records of data; and
wherein determining the comparison indicates one or more discrepancies exist in the one or more records of data maintained in the DWH comprises determining at least one of inaccurate information or missing information exists in the one or more features of the received one or more records of data maintained in the DWH.

13. The system of claim 12, wherein the method further comprises determining to issue, by the one or more microservices of the multiple microservices, a reconciliation event for a record of the one or more records of data maintained in the DWH based, at least in part, on a score calculated for the comparison, wherein the score is calculated based on:
a number of features analyzed in the record maintained in the DWH and its corresponding record of the one or more corresponding records of data, and
a number of features in the record maintained in the DWH that did not match a corresponding feature in the corresponding record.

14. The system of claim 8, wherein comparing, by each microservice, the received one or more records of data maintained in the DWH with the one or more corresponding records of data obtained by each microservice comprises:
comparing a number of the received one or more records of data maintained in the DWH with a number of the one or more corresponding records of data; and
wherein determining the comparison indicates one or more discrepancies exist in the one or more records of data maintained in the DWH comprises determining the number of the received one or more records of data maintained in the DWH is not equal to the number of the one or more corresponding records of data.

15. A non-transitory computer-readable medium comprising instructions that, when executed by one or more processors of a computing system, cause the computing system to perform a method for data validation and reconciliation of data stored in a data warehouse (DWH) by multiple microservices in communication with the DWH, the method comprising:
receiving, by each microservice of the multiple microservices, one or more records of data maintained in the DWH, wherein the one or more records received by each microservice originated from that microservice;
obtaining, by each microservice, one or more corresponding records of data in a database maintained by each microservice that corresponds to the received one or more records of data maintained in the DWH;
performing, by each microservice, a validation process to validate the received one or more records of data maintained in the DWH by comparing the received one or more records of data maintained in the DWH with the one or more corresponding records of data;
determining, by one or more microservices of the multiple microservices, the comparison of the received one or more records of data maintained in the DWH with the one or more corresponding records of data indicates one or more discrepancies exist in the one or more records of data maintained in the DWH; and
issuing, by the one or more microservices of the multiple microservices, one or more reconciliation events to remediate the one or more discrepancies which exist in the received one or more records of data maintained in the DWH.

16. The non-transitory computer-readable medium of claim 15, wherein each microservice of the multiple microservices receives the one or more records maintained in the DWH from a crawler that queries the one or more records according to at least one of a preconfigured schedule or a batch size.

17. The non-transitory computer-readable medium of claim 16, wherein the one or more records are received from the crawler through a message broker that translates the one or more records to a format used by its respective microservice where the one or more records originated from.

18. The non-transitory computer-readable medium of claim 15, wherein the database maintained by each microservice comprises a system of record (S OR) that is an authoritative data source for data generated by each microservice.

19. The non-transitory computer-readable medium of claim 15, wherein comparing, by each microservice, the received one or more records of data maintained in the DWH with the one or more corresponding records of data obtained by each microservice comprises:
comparing one or more features of the received one or more records of data maintained in the DWH with one or more features of the one or more corresponding records of data; and
wherein determining the comparison indicates one or more discrepancies exist in the one or more records of data maintained in the DWH comprises determining at least one of inaccurate information or missing information exists in the one or more features of the received one or more records of data maintained in the DWH.

20. The non-transitory computer-readable medium of claim 19, wherein the method further comprises determining to issue, by the one or more microservices of the multiple microservices, a reconciliation event for a record of the one or more records of data maintained in the DWH based, at least in part, on a score calculated for the comparison, wherein the score is calculated based on:
a number of features analyzed in the record maintained in the DWH and its corresponding record of the one or more corresponding records of data, and
a number of features in the record maintained in the DWH that did not match a corresponding feature in the corresponding record.
